(19) United States
(12) Patent Application Publication
(10) Pub. No.: US 2004/0216343 A1
(43) Pub. Date: Nov. 4, 2004

(54) Address illumination assembly

(76) Inventor: Glenmore A. Golding, Elmont, NY (US)

Correspondence Address: Richard C. Litman, LITMAN LAW OFFICES, LTD., P.O. Box 15035, Arlington, VA, 22215, US

(21) Appl. No.: 10/861,351

(22) Filed: Jun. 7, 2004

Related U.S. Application Data
(63) Continuation-in-part of application No. 10/152,911, filed on May 23, 2002, now Pat. No. 6,745,507.

(51) Int. Cl. G09F 13/04

(52) U.S. Cl. 40/564; 40/580

(57) ABSTRACT

An address illumination assembly includes at least one alphanumeric element and has a housing with a front and a rear. A solar panel, an alphanumeric character, and at least one rechargeable battery are in the housing and are electrically interconnected with the solar panel and the alphanumeric character. At least one light emitting diode (LED) and lighting circuitry are in the housing, and a cover is interconnected with the housing. The alphanumeric character may be configured as an optic light guide in the form of flexible transparent cable that includes at least one LED inlet, and at least one refractor along the length of the optic light guide. Alternatively, the alphanumeric character may be carved or etched in a surface of a flat rectangular plate-like member, and the solar panel may be positioned on the top of the housing and extend perpendicular to the housing, or vertical to the housing.

### CROSS REFERENCE TO RELATED APPLICATION

This application is a continuation-in-part of U.S. application Ser. No. 10/152,911, filed May 23, 2002, which is incorporated herein by reference.

### BACKGROUND OF THE INVENTION

1. Field of the Invention

The present invention relates generally to illuminated address systems and, more particularly, to an address illumination assembly that illuminates address indicia based on ambient light conditions.

2. Description of the Related Art

Society is not immune to natural or other disasters that necessitate quick response from emergency service departments, such as fire departments, police, or the like. In the prior art, various and different types of illuminated displays have been proposed for building or house addresses.

The related art is represented by the following references of interest.

U.S. Patent Application Publication No. 2002/0003697 A1, published on Jan. 10, 2002 for Tseng-Lu Chien, describes an outdoor lighting with organic elements. The Chien application does not disclose an address illumination assembly according to the claimed invention.

U.S. Pat. No. 2,694,270, issued Nov. 16, 1954 to Ina Jean B. Sptizer, describes an illuminated sign. The Spitzer patent does not disclose an address illumination assembly according to the claimed invention.

U.S. Pat. No. 4,532,579, issued Jul. 30, 1985 to Bill Merryman, describes an illuminated interconnectable sign module. The Merryman patent does not disclose an address illumination assembly according to the claimed invention.

U.S. Pat. No. 4,848,017, issued Jul. 18, 1989 to James M. Bailey et al., describes an illuminated building number assembly. The Bailey et al. patent does not disclose an address illumination assembly according to the claimed invention.

U.S. Pat. No. 4,951,406, issued Aug. 28, 1990 to Honoré M. Lemire, describes an illuminated sign for residence street address. The Lemire patent does not disclose an address illumination assembly according to the claimed invention.

U.S. Pat. No. 5,020,253, issued Jun. 4, 1991 to Liat-Chaw Lie et al., describes a display board assembly which includes a start unit connected to an end unit with a variety of intermediate display units set in therebetween in line. The Lie et al. patent does not disclose an address illumination assembly according to the claimed invention.

U.S. Pat. No. 5,771,617, issued Jun. 30, 1998 to Paul Baker, describes a display device that is incorporated into a building structure and includes at least one rigid block composed of a robust grindable composition. The Baker patent does not disclose an address illumination assembly according to the claimed invention.

U.S. Pat. No. 6,401,373 B1, issued Jun. 11, 2002 to Clifford E. Sexton, describes an illuminated address display that includes a generally angular light housing defining an interior space and an open front. The Sexton patent does not disclose an address illumination assembly according to the claimed invention.

U.S. Pat. No. 6,568,109 B2, issued May 27, 2003 to Eddie Sanders, describes an address display device that can automatically adjust its light output intensity to ambient light conditions and is readily changeable to any address. The Sanders patent does not disclose an address illumination assembly according to the claimed invention.

Additional related art includes U.S. Pat. No. 568,204, issued Sep. 22, 1896 to Mortimer Norden, describing an electric sign; U.S. Pat. No. 814,684, issued Mar. 13, 1906 to Samuel W. Fleming et al., describing an illuminated sign; U.S. Pat. No. 1,760,767, issued May 27, 1930 to Georg G. Müller, describing an illuminating structure; U.S. Pat. No. 1,192,803, issued Jul. 25, 1916 to James E. Tucker et al., describing an electrically-illuminated display device; and U.S. Pat. No. 2,479,500, issued Aug. 16, 1949 to Harry E. Longberg, describing an illuminating means.

Additional related art includes U.S. Pat. No. 3,310,670, issued Mar. 21, 1967 to Ronald W. Sheppard, describing a sealed illuminator; U.S. Pat. No. 4,768,300, issued on Sep. 6, 1988 to Renzo N. Rutili, describing an illuminated information display; U.S. Pat. No. 4,854,062, issued Aug. 8, 1989 to Luis E. Bayo, describing an illuminated house number device; U.S. Pat. No. 4,901,461, issued Feb. 20, 1990 to Raymond A. Edwards et al., describing a house identification fixture; and U.S. Pat. No. 5,526,236, issued Jun. 11, 1996 to James J. Burnes et al., describing a lighting device used in an exit sign.

Additional related art includes U.S. Pat. No. 5,563,565, issued May 27, 1997 to Roni Friedman et al., describing an electronic flasher circuit; U.S. Pat. No. 5,778,579, issued Jul. 14, 1998 to Shu Wing Yuen, describing an illuminated house number; U.S. Pat. No. 5,911,524, issued Jun. 15, 1999 to Timothy B. Wilton, describing an automated, illuminated address display and entrance light; and U.S. Pat. No. 6,060,838, issued May 9, 2000 to James L. Cantoni et al., describing an illumination device.

Additional related art includes U.S. Pat. No. 6,098,326, issued Aug. 8, 2000 to Warren A. Campbell, III, describing a locator sign; U.S. Pat. No. 6,177,877 B1, issued Jan. 23, 2001 to Timothy Munyon, describing a hand-held programmable sign with a rotatable handle; U.S. Pat. No. 6,276,079 B1, issued Aug. 21, 2001 to Veso S. Tijanic, describing a reflective display with front lighting; U.S. Pat. No. 6,299,325 B1, issued Oct. 9, 2001 to Wayne Cathel, describing an illuminating address indication device; U.S. Pat. No. 6,326,735, issued Dec. 4, 2001 to Shaw-Jong Wang et al., describing a long-life type colorful electroluminescent display panel; and U.S. Pat. No. 6,341,440 B1, issued Jan. 29, 2002 to Ching-Chuan Lee, describing a multi-function signboard.

Foreign related art includes World Intellectual Property Organization (WIPO) Patent Application Publication No. WO 90/07173, published Jun. 28, 1990, describing an information display device; and Japan Patent Application Publication No. 3-235987, published Oct. 21, 1991, describing a graphic panel.

None of the above references, taken either singularly or in combination, is seen to describe the instant invention as claimed. Thus an address illumination assembly solving the aforementioned problems is desired.

### SUMMARY OF THE INVENTION

The present invention is an address illumination assembly including at least one alphanumeric element having a housing with a front and a rear. A solar panel, an alphanumeric character, and at least one rechargeable battery are in the housing and are operably interconnected with the solar panel and the alphanumeric character. Lighting circuitry and at least one light emitting diode are also in the housing, and a cover is interconnected with the housing.

The housing includes a panel at the rear of the housing that is removable via at least one fastener and is configured to be mounted/attached to a surface. The alphanumeric character may be configured as an optic light guide in the form of flexible transparent cable that includes at least one LED inlet, and at least one refractor along the length of the optic light guide. The alphanumeric character may be attached/positioned on the solar panel proximate the front of the housing. Alternatively, the alphanumeric character may be carved or etched in a surface of a flat rectangular plate-like member, and the solar panel may be positioned on the top of the housing and extend perpendicularly in the front of the housing, or extend vertically above the top of the housing.

The solar panel is a rectangular plate-like member that converts sunshine during daylight hours to electrical energy and can power one or more LED(s) in the housing and/or can recharge the rechargeable battery(s) in the housing. The solar panel includes one or more solar cells and is operably connected via a transistor switch to the rechargeable battery(s) and to the LED(s) via the lighting circuitry.

During daylight hours sunlight or light from other light sources is absorbed by the solar panel, and causes the solar panel to generate electrical energy and charge the rechargeable battery(s). The transistor switch prevents any electrical energy generated by the solar panel to power the LED(s). When the ambient light level falls below a predetermined threshold the transistor switch causes electrical energy stored in the rechargeable battery(s) to power the LED(s).

Accordingly, it is a principal aspect of the invention to provide an address illumination assembly that improves visibility and aesthetic appeal.

It is another aspect of the invention to provide an address illumination assembly that is adaptable for residential, commercial, and industrial use.

It is an aspect of the invention to provide improved elements and arrangements thereof in an address illumination assembly for the purposes described which is inexpensive, dependable and fully effective in accomplishing its intended purposes.

### BRIEF DESCRIPTION OF THE DRAWINGS

FIG. 1 is a front perspective view of an address illumination assembly according to the present invention.

FIG. 2 is a front perspective exploded view of a left bracing element of an address illumination assembly according to the present invention.

FIG. 3 is a front perspective exploded view of a right bracing element of an address illumination assembly according to the present invention.

FIG. 4A is a front perspective view of a sensor element of an address illumination assembly according to the present invention.

FIG. 4B is a front perspective exploded view of a sensor element of an address illumination assembly according to the present invention.

FIG. 5 is a circuit diagram of circuitry on a sensor board element of an address illumination assembly according to the present invention.

FIG. 6A is a front perspective view of an alphanumeric element of an address illumination assembly according to the present invention.

FIG. 6B is a front perspective exploded view of an alphanumeric element of an address illumination assembly according to the present invention.

FIG. 7 is a front view of a lighting board of an address illumination assembly according to the present invention.

FIG. 8 is a front perspective view of an address illumination assembly according to the present invention.

FIG. 9A is a front perspective view of a sensor element of an address illumination assembly according to the present invention.

FIG. 9B is a front perspective exploded view of a sensor element of an address illumination assembly according to the present invention.

FIG. 10 is a circuit diagram of circuitry on a sensor board element of an address illumination assembly according to the present invention.

FIG. 11A is a front perspective view of an alphanumeric element of an address illumination assembly according to the present invention.

FIG. 11B is a front perspective exploded view of an alphanumeric element of an address illumination assembly according to the present invention.

FIG. 12 is a front view of a lighting board of an address illumination assembly according to the present invention.

FIG. 13 is a front perspective view of an alphanumeric element of an address illumination assembly according to the present invention.

FIG. 14 is a front perspective view of an alphanumeric element of an address illumination assembly according to the present invention.

FIG. 15A is a front perspective view of an alphanumeric element of an address illumination assembly according to the present invention.

FIG. 15B is a front perspective view of an alphanumeric element of an address illumination assembly according to the present invention.

FIG. 16 is a block diagram of any of the alphanumeric elements in FIGS. 13-15B.

FIG. 17 is circuitry for any of the alphanumeric elements in FIGS. 13-15B.

Similar reference characters denote corresponding features consistently throughout the attached drawings.

### DETAILED DESCRIPTION OF THE PREFERRED EMBODIMENTS

This present invention is an address illumination assembly.

The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

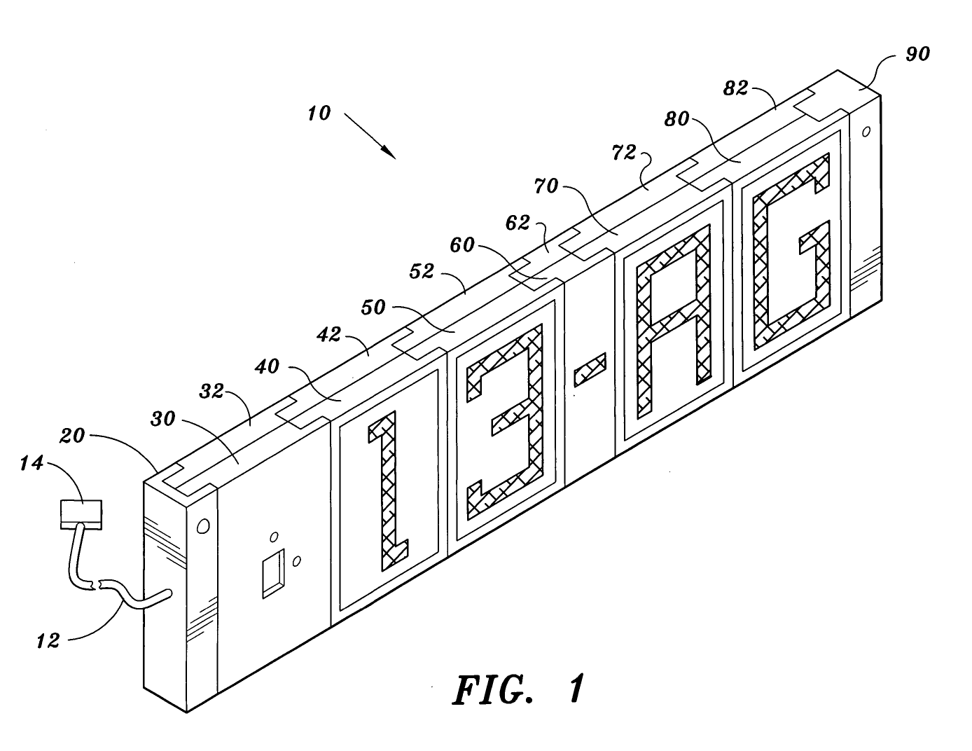

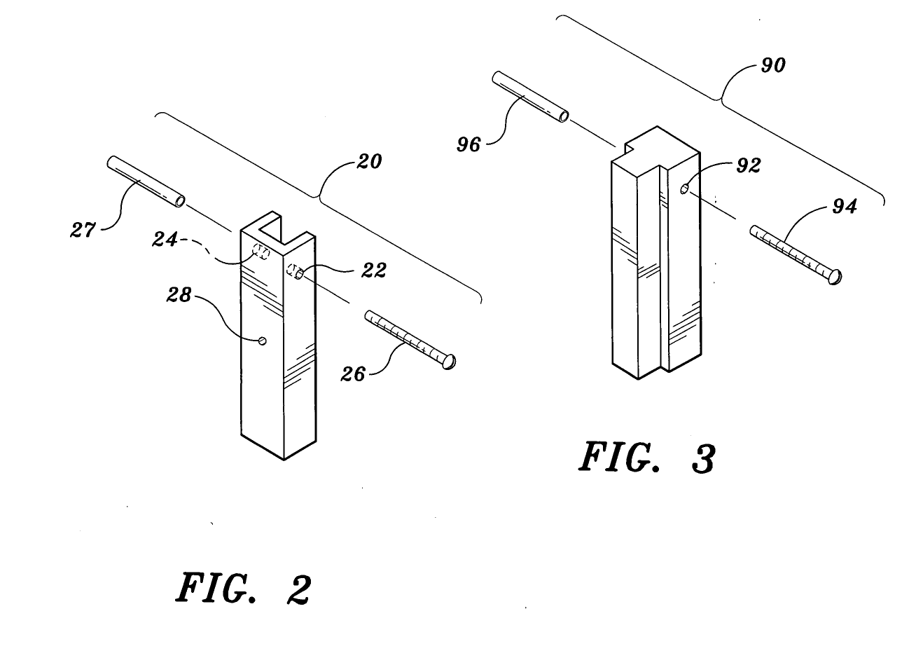

Referring to the drawings, FIGS. 1-7 illustrate one example of an address illumination assembly 10 that includes first and second end elements, a sensor element, and at least one alphanumeric element. The first and second end elements 20,90 are configured to secure together the sensor element and the alphanumeric elements. As shown in FIG. 2A, the first end element 20 is generally configured in the form of a “U”, e.g., the first end element includes a base with two sides longitudinally extending from ends of the first end element base that define therebetween a recess configured to cooperate with the sensor element. The base has an aperture 28 defined therein having a size configured to receive a power cord from the sensor element. The two sides of the first end element each have an aperture 22,24 defined therein having a size configured to receive a fastener, such as a screw, therethrough to provide the ability to fasten the illumination assembly to an appropriate mount.

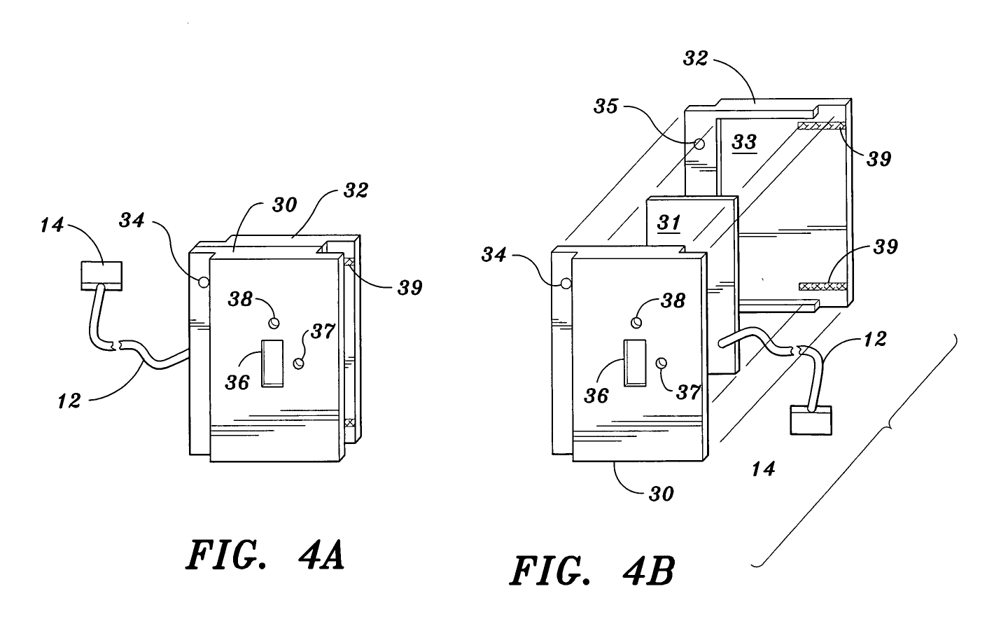

As shown in FIG. 3, the second end element 90 is generally configured in the form of a “T”, e.g., the second end element 90 includes a base with one side longitudinally extending from a central portion of the base that is configured to cooperate with an alphanumeric element. The base has an aperture 92 defined therein having a size configured to receive a fastener, such as screw, therethrough to provide the ability to fasten the illumination assembly to an appropriate mount. The assembly may also include a member to receive the fastener.

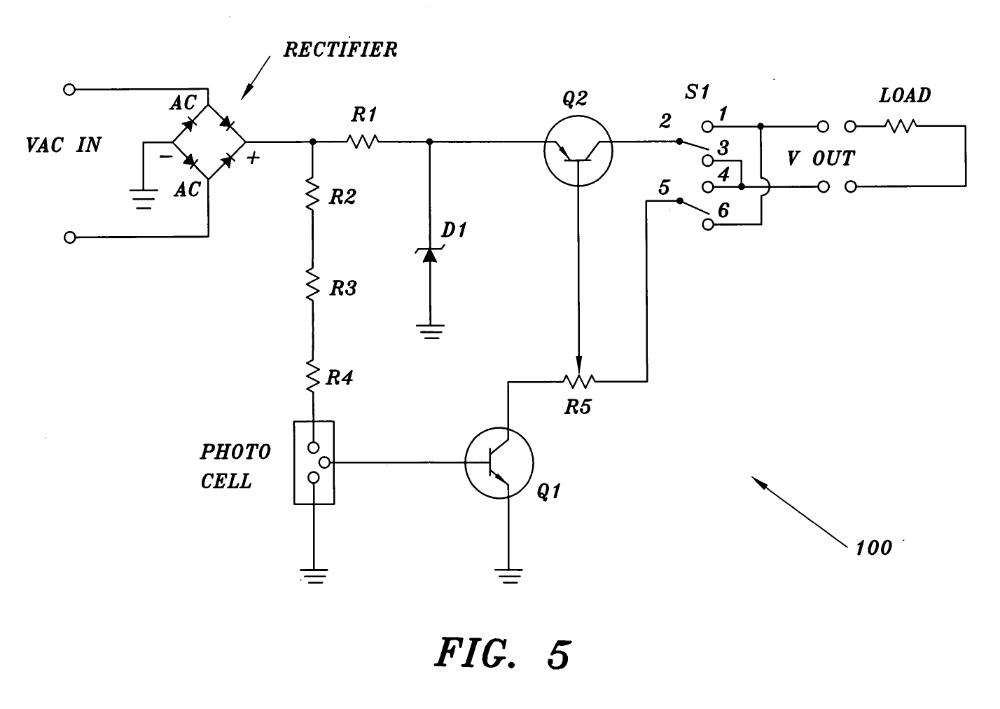

A shown in FIGS. 4A and 4B, the sensor element includes a sensor cover 30, a sensor base 32, and a sensor printed circuit board 31 positioned therebetween. The sensor cover 30 and sensor base 32 each include peripheral side walls extending therefrom that cooperate with each other to form the sensor element and provide a cavity wherein the sensor printed circuit board 31 is housed. The sensor cover 30 has an aperture 34 defined therein near an edge that has a size configured to receive a fastener, such as screw, therethrough to provide the ability to fasten the illumination assembly to an appropriate mount. The sensor cover also has three apertures 36,37,38 defined therein that have sizes configured to receive a photo sensor element, a bipolar switch element, and a potentiometer switch element.

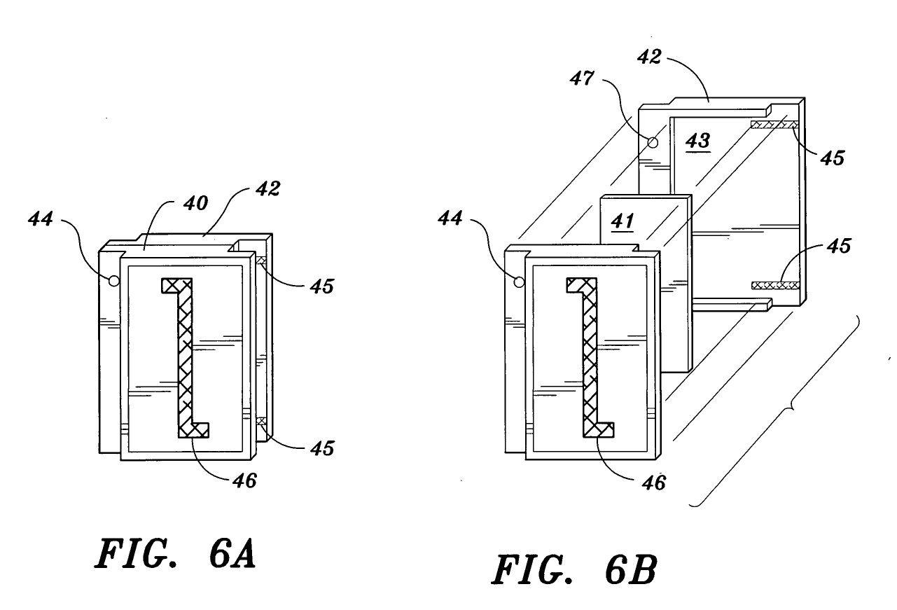

The sensor base 32 includes electrical contacts 39 to pass electric current from the sensor element to another element. The sensor base 32 has plural apertures 35 defined therein having a size configured to receive a fastener, such as screw, therethrough to provide the ability to fasten the illumination assembly to an appropriate mount or to fasten the sensor base 32 to the sensor cover. The sensor printed circuit board 31 includes an electrical circuit 100 that includes a photo sensor, a bipolar switch, a potentiometer switch, and associated electrical elements and wiring (see FIG. 5).

The photo sensor, such as a photo cell or the like, monitors the ambient light level and switches the light sources on when the ambient light level falls below a predetermined threshold and switches the light sources off when the ambient light level rises above the predetermined threshold. The potentiometer switch may be adjusted to set the predetermined threshold at a desired amount. The printed circuit board 31 also includes a power cord 12 for receiving external AC power voltage, such as power to a doorbell switch or from an AC adaptor via a connector 14. The electrical circuit 100 rectifies and regulates the external power voltage down to a DC voltage for driving light sources of the alphanumeric elements. For example, the illumination assembly may be connected in the circuit across the terminals of a doorbell, buzzer, or chime of a residence. The construction and operation of such electrical elements and such an electrical circuit are well known in the art. This invention is not limited to any particular electrical circuit.

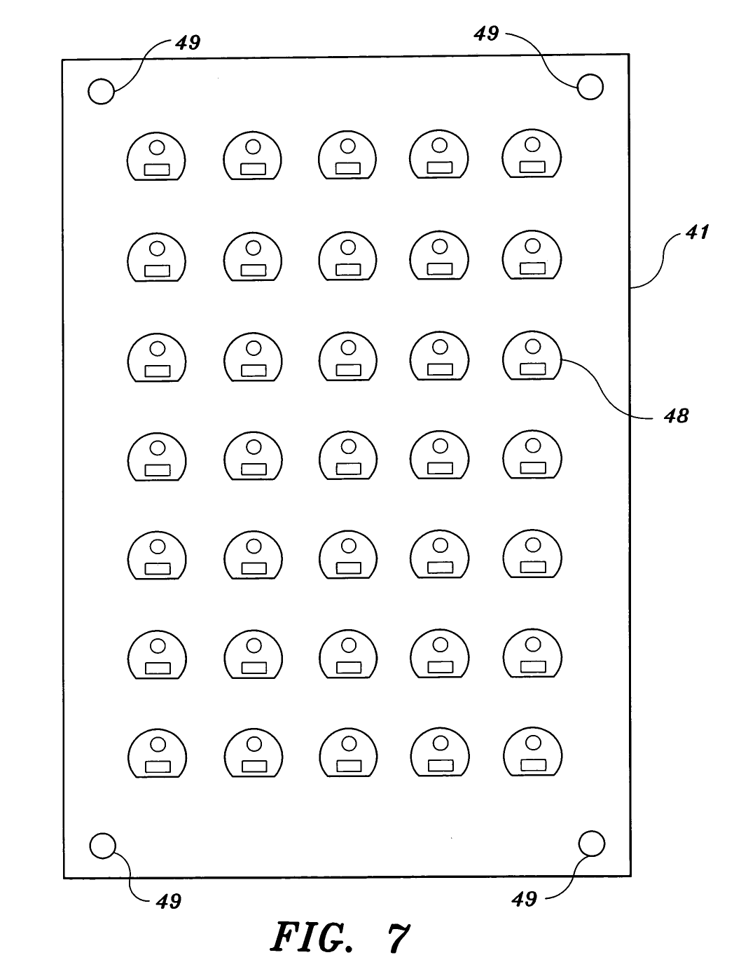

As shown in FIGS. 6A and 6B, the alphanumeric element includes an alphanumeric cover 40, an alphanumeric base 42, and a universal alphanumeric light board 41 positioned therebetween. The alphanumeric cover 40 and alphanumeric base 42 each include peripheral side walls extending therefrom that cooperate with each other to form the alphanumeric element and provide a cavity wherein the alphanumeric universal light board 41 is housed. The alphanumeric cover 40 has a front side and a back side. The front and back side each have portions that may include a transparent portion, a translucent portion, an opaque portion, or combinations thereof.

A transparent or translucent portion may be configured in the form of an alphanumeric character 46 such as a number, a letter, or the like. The transparent or translucent portion may be clear, tinted, shaded, or colored according to the desires of the user. For example, the transparent or translucent portion may be colored in any of a variety of colors, such as red, orange, white, green, blue, or the like. The opaque portion may also be colored in any of a variety of colors, such as grainy, light yellow, off-white, black marble, orange, granite, or the like. The front side is generally smooth, but may include a recess for the alphanumeric character 46. The back side 42 includes electrical contacts 45 to pass electric current from the alphanumeric element to another element. The back side includes plural extending or recessed bosses configured to receive a fastener, such as screw, therethrough to provide the ability to fasten the alphanumeric cover 40 to the alphanumeric base 42, and to fasten an alphanumeric element to another alphanumeric element, a sensor element, or an end element.

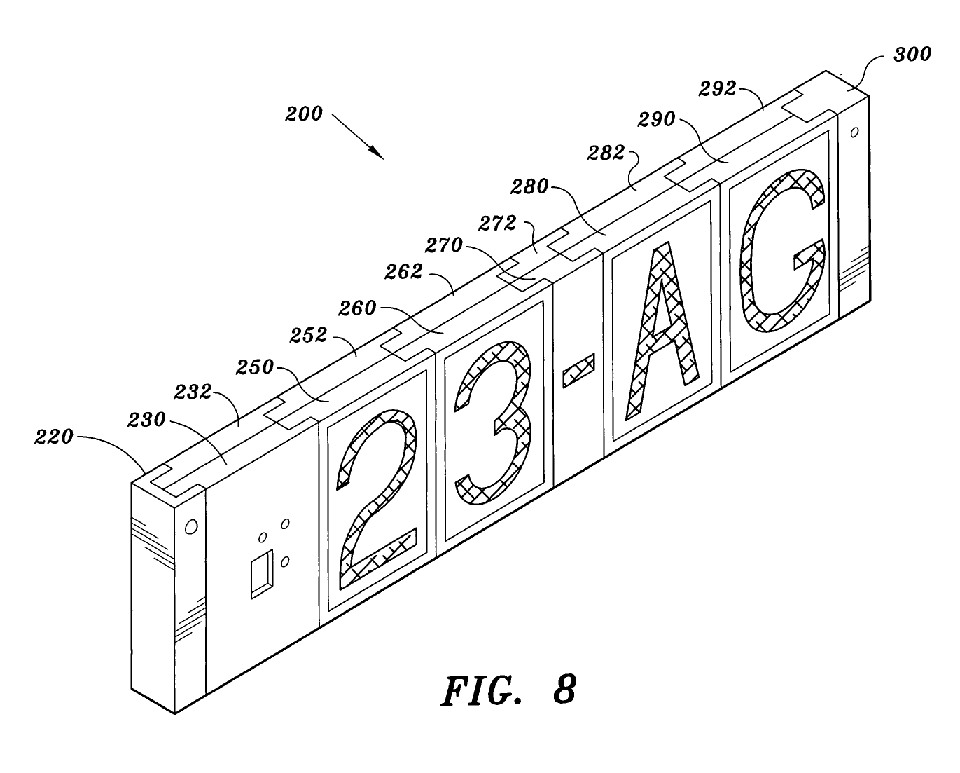

As shown in FIG. 7, the universal alphanumeric light board 41 includes an X-Y array of light sources 48, such as an array of seven rows by five columns, to emit light in a direction away from the light board. The light sources 48 may be light emitting diodes (LEDs) or any other suitable light source. The light sources 48 are mounted in the light board 41 in a conventional manner, e.g., by soldering the leads (i.e., anode and cathode) to the light board 41 such that the light sources 48 are properly oriented.

The address illumination assembly 10 may also include alphanumeric element that includes an alphanumeric cover 60 and an alphanumeric base 62, and does not include a universal alphanumeric light board positioned therebetween (see FIG. 1). The configuration of such an alphanumeric element is substantially the same as the alphanumeric element described above. However, the alphanumeric cover 60 of such an alphanumeric element is opaque and does not include a transparent or translucent portion. For example, such an alphanumeric element may be configured for particular symbols, such as a dash, and be smaller in size than other alphanumeric elements. This alphanumeric element may also be colored according to the desires of the user. For example, this alphanumeric element may be colored in accordance with any corresponding end, sensor, and/or alphanumeric elements.

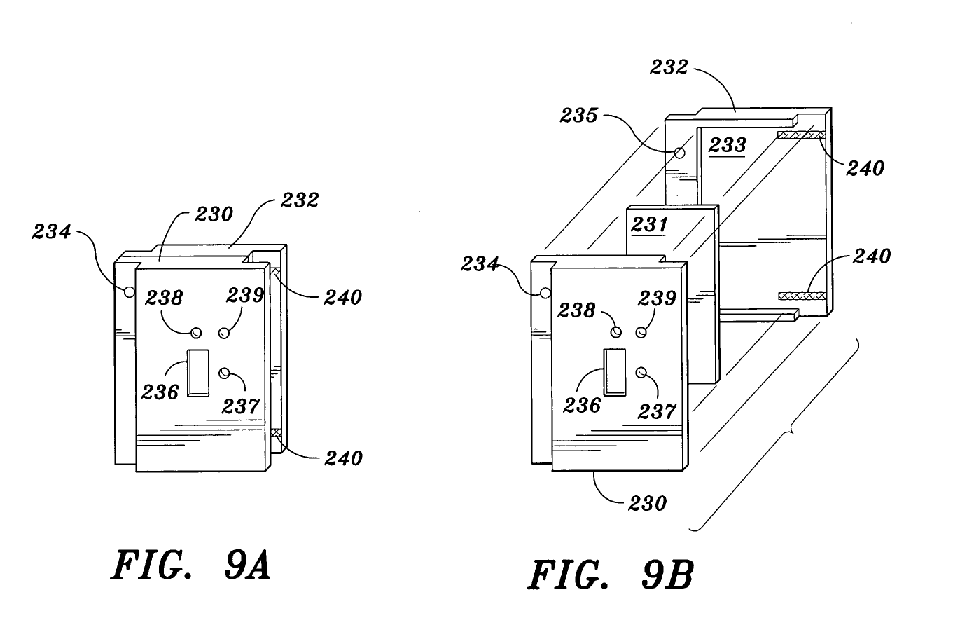

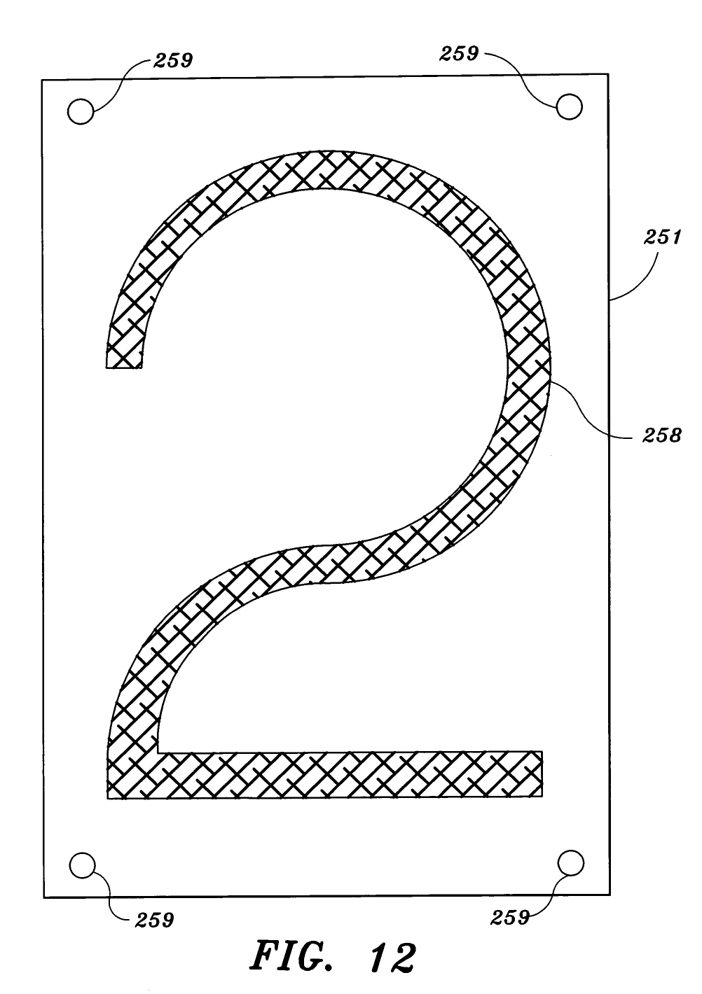

FIGS. 8-12 illustrate another example of an address illumination assembly 200 that includes first and second end elements, a sensor element, and at least one alphanumeric element. Address illumination assembly 200 is configured for replacing a conventional door bell or door buzzer (not shown) The first and second end elements are configured to secure together the sensor element and the alphanumeric elements. As with address illumination assembly 10, the first end element 220 is generally configured in the form of a “U”, e.g., the first end element includes a base with two sides longitudinally extending from ends of the first end element base that define therebetween a recess configured to cooperate with the sensor element. The two sides of the first end element each have an aperture defined therein having a size configured to receive a fastener, such as a screw, therethrough to provide the ability to fasten the illumination assembly to an appropriate mount.

The second end element is generally configured in the form of a “T”, e.g., the second end element includes a base with one side longitudinally extending from a central portion of the base that is configured to cooperate with an alphanumeric element. The base has an aperture defined therein having a size configured to receive a fastener, such as screw, therethrough to provide the ability to fasten the illumination assembly to an appropriate mount. The assembly may also include a member to receive the fastener.

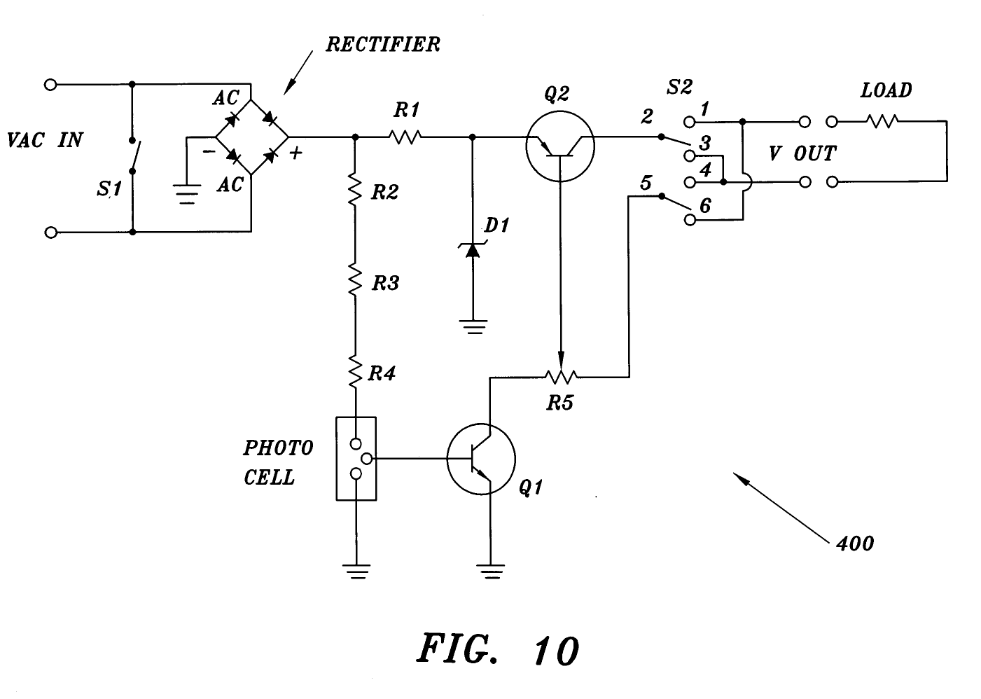

As shown in FIGS. 9A and 9B, the sensor element includes a sensor cover 230, a sensor base 232, and a sensor printed circuit board 231 positioned therebetween. The sensor cover 230 and sensor base 232 each include peripheral side walls extending therefrom that cooperate with each other to form the sensor element and provide a cavity wherein the sensor printed circuit board 231 is housed. The sensor cover 230 has an aperture 234 defined therein near an edge that has a size configured to receive a fastener, such as screw, therethrough to provide the ability to fasten the illumination assembly to an appropriate mount. The sensor cover 230 also has three apertures 236,237,238 defined therein that have sizes configured to receive a photo sensor element, a bipolar switch element, and a potentiometer switch element. In addition, the sensor cover 230 has an aperture defined therein configured to receive a push button or switch 239 to activate a doorbell, chimes, or the like.

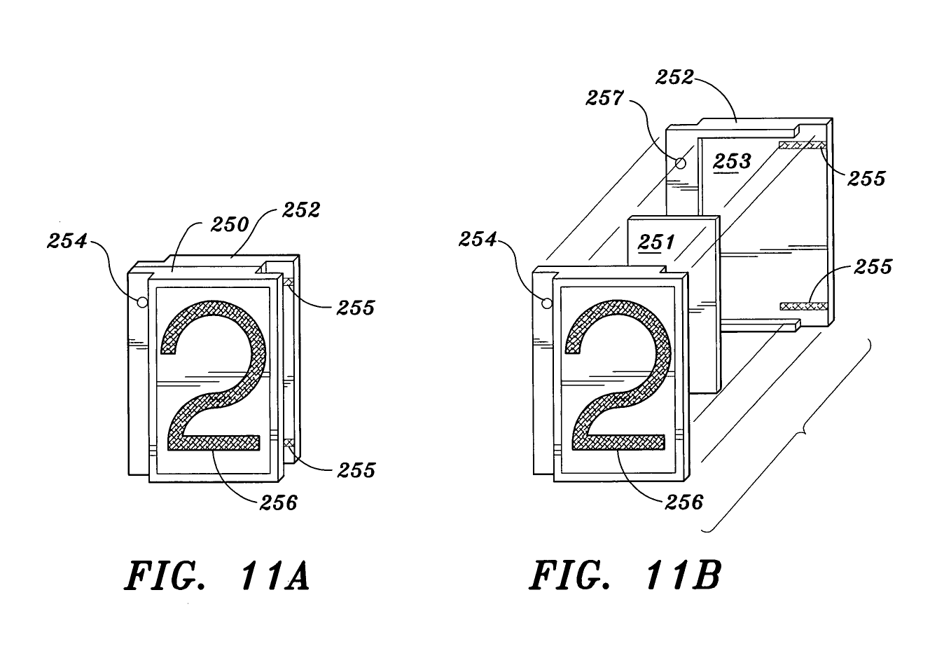

The sensor base 232 includes electrical contacts 240 to pass electric current from the sensor element to another element. The sensor base 232 has at least one aperture 235 defined therein having a size configured to receive a fastener, such as screw, therethrough to provide the ability to fasten the illumination assembly to an appropriate mount or to fasten the sensor base 232 to the sensor cover 230. The sensor printed circuit board 231 includes an electrical circuit 400 that includes a switch S1, a photo sensor, a bipolar switch, a potentiometer switch, and associated electrical elements and wiring (see FIG. 10).

Switch S1 corresponds to push button or switch 239. The photo sensor, such as a photo cell or the like, monitors the ambient light level and switches the light sources on when the ambient light level falls below a predetermined threshold and switches the light sources off when the ambient light level rises above the predetermined threshold. The potentiometer switch may be adjusted to set the predetermined threshold at a desired amount. The printed circuit board 231 receives external AC power voltage from a doorbell switch or the like. The electrical circuit 400 rectifies and regulates the external power voltage down to a DC voltage for driving light sources of the alphanumeric elements. For example, the illumination assembly may be connected in the circuit across the terminals of a doorbell, buzzer, or chime of a residence. The construction and operation of such electrical elements and such an electrical circuit are well known in the art. This invention is not limited to any particular electrical circuit.

The alphanumeric element includes an alphanumeric cover 250, an alphanumeric base 252, and an alphanumeric light board 251 positioned therebetween. The alphanumeric cover 250 and alphanumeric base 252 each include peripheral side walls extending therefrom that cooperate with each other to form the alphanumeric element and provide a cavity wherein the alphanumeric universal light board 251 is housed. The alphanumeric cover 250 has a front side and a back side. The front and back side each have portions that may include a transparent portion, a translucent portion, an opaque portion, or combinations thereof.

A transparent or translucent portion may be configured in the form of an alphanumeric character 256 such as a number, a letter, or the like. The transparent or translucent portion may be clear, tinted, shaded, or colored according to the desires of the user. For example, the transparent or translucent portion may be colored in any of a variety of colors, such as red, orange, white, green, blue, or the like. An opaque portion may also be colored in any of a variety of colors, such as grainy, light yellow, off-white, black marble, orange, granite, or the like. The front side is generally smooth, but may include a recess for the alphanumeric character 256. The back side 252 includes electrical contacts 255 to pass electric current from the alphanumeric element to another element. The back side includes plural extending or recessed bosses configured to receive a fastener, such as screw, therethrough to provide the ability to fasten the alphanumeric cover 250 to the alphanumeric base 252, and to fasten an alphanumeric element to another alphanumeric element, a sensor element, or an end element.

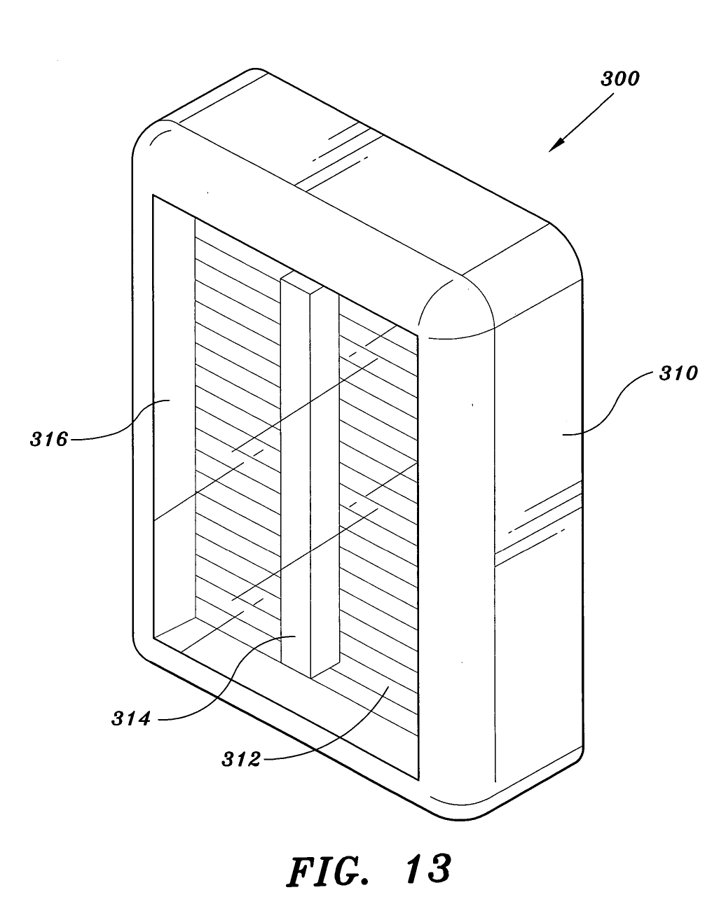

FIG. 12 illustrates an alphanumeric light board that includes a light transmission tube 258 and a light source disposed at at least one axial end of the light transmission tube. The light transmission tube 258 is configured in the form of a predetermined alphanumeric character. The light transmission tube 258 may be any known light transmission tube. For example, a flexible material moldable into a tube form may be employed, such as plastic, elastomer, or the like. The diameter and length of the, light transmission tube 258 may be determined according to the desires of the user. The light source may be an LED or any other suitable light source. The light source and light transmission tube 258 are mounted on the light board 251 in a conventional manner.

The address illumination assembly 200 may also include alphanumeric element that includes an alphanumeric cover 270 and an alphanumeric base 272, and does not include a universal alphanumeric light board positioned therebetween (see FIG. 8). The configuration of such an alphanumeric element is substantially the same as the alphanumeric element described above. However, the alphanumeric cover 270 of such an alphanumeric element is opaque and does not include a transparent or translucent portion. For example, such an alphanumeric element may be configured for particular symbols, such as a dash, and be smaller in size than other alphanumeric elements. This alphanumeric element may also be colored according to the desires of the user. For example, this alphanumeric element may be colored in accordance with any corresponding end, sensor, and/or alphanumeric elements.

The end elements, sensor cover, sensor base, alphanumeric covers, and alphanumeric bases may be made from any desirable material, such as plastic, metal, wood, etc., and may be dimensioned according to the desires of the manufacturer.

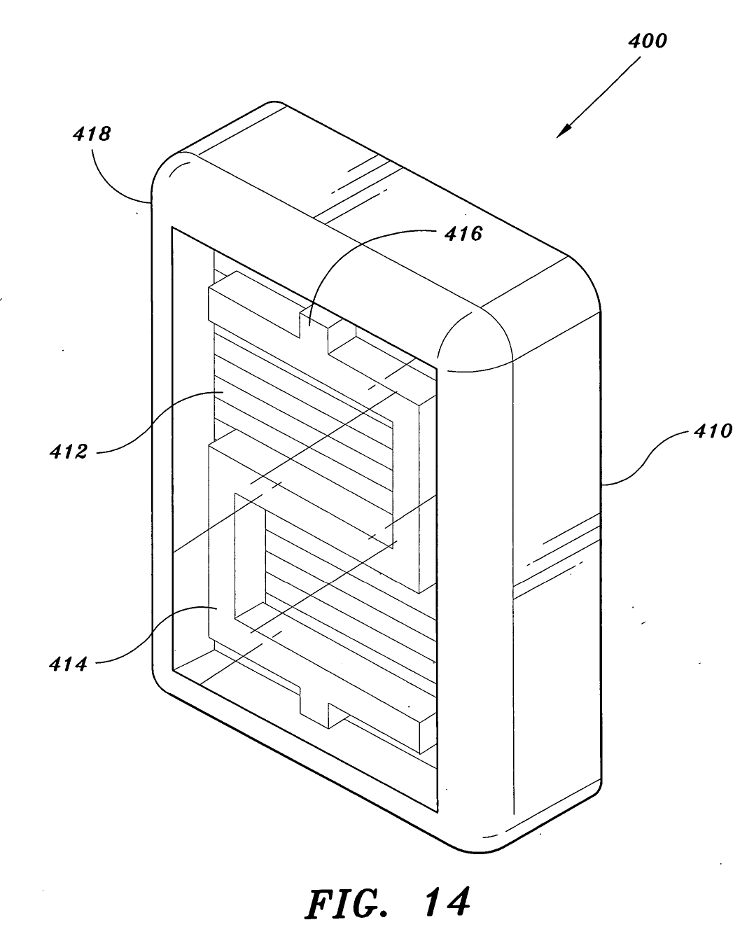

FIGS. 13-15B illustrate address illumination elements 300, 400, 500, and 520 that are each independently operable via solar power and/or rechargeable batteries interconnected therein. Address illumination element 300 in FIG. 13 has a housing 310, a solar panel 312, an alphanumeric character 314, and a cover 316. The housing 310 is generally rectangular, includes a front, rear, top, bottom, left, and right sides. The housing 310 includes a panel at the rear of the housing 310 that is removable via fastener(s) and is configured to be mounted and/or attached to a surface, such as a side of a house, a mailbox, etc. The housing 310 is preferably made of a rugged impact resistant resin, such as acrylonitrile/butadiene/styrene (ABS), polyvinyl chloride (PVC), polypropylene, polycarbonate, etc. One or more rechargeable batteries and lighting circuitry are contained within the housing 310. Each battery is preferably a AA size 900 mAh NiCad battery, though other rechargeable battery configurations may also be used.

The solar panel 312 is a flat rectangular plate-like member that converts sunshine during daylight hours to electrical energy 5 and can power one or more LED(s) in the housing 310 and/or can recharge the rechargeable battery(s) in the housing 310. The solar panel 312 includes one or more solar cells, such as photovoltaic cells or the like, and is operably connected via a transistor switch to the rechargeable battery(s) and to the LED(s) via the lighting circuitry.

During daylight hours sunlight or light from other light sources is absorbed by the solar panel 312, and causes the solar panel 312 to generate electrical energy and charge the rechargeable battery(s). The transistor switch prevents any electrical energy generated by the solar panel 312 to power the LED(s) until the ambient light level falls below a predetermined threshold, and then the transistor switch causes electrical energy stored in the rechargeable battery(s) to power the LED(s). The lighting circuitry may contain additional circuitry to adjust the ambient light level predetermined threshold, to prevent the rechargeable battery(s) from charging above a predetermined maximum level, to allow the LED(s) to be powered during daylight hours, etc.

The cover 316 is a flat plate-like member and is formed of transparent or translucent material of any suitable type, including acrylic, glass, polycarbonate, epoxy, resins, etc. The cover 316 is positioned on the front of the housing above the alphanumeric character 314. The solar panel 312 is positioned behind the alphanumeric character 314 within the housing 310. However, the solar panel 312 may alternatively be positioned on the top, bottom, left, or right side of the housing 310 as desired.

The alphanumeric character 314 shown in FIG. 13 is configured as an optic light guide in the form of a “1” (one), but may be configured in the form of any desired alphanumeric character. The optic light guide or alphanumeric character 314 is preferably a flexible transparent cable that includes one or more LED inlets, and one or more refractors along the length of the light guide. Light emitted from each LED is passed through an LED inlet. Each refractor refracts the light from an LED as it passes through the refractor to concentrate the light into a concentrated round beam pattern. While any number of refractors may be utilized, the uniformity of light emitted through the light guide increases with the number of refractors employed. The alphanumeric character 314 is attached to and/or is positioned on the surface of the solar panel 312 proximate the cover 316.

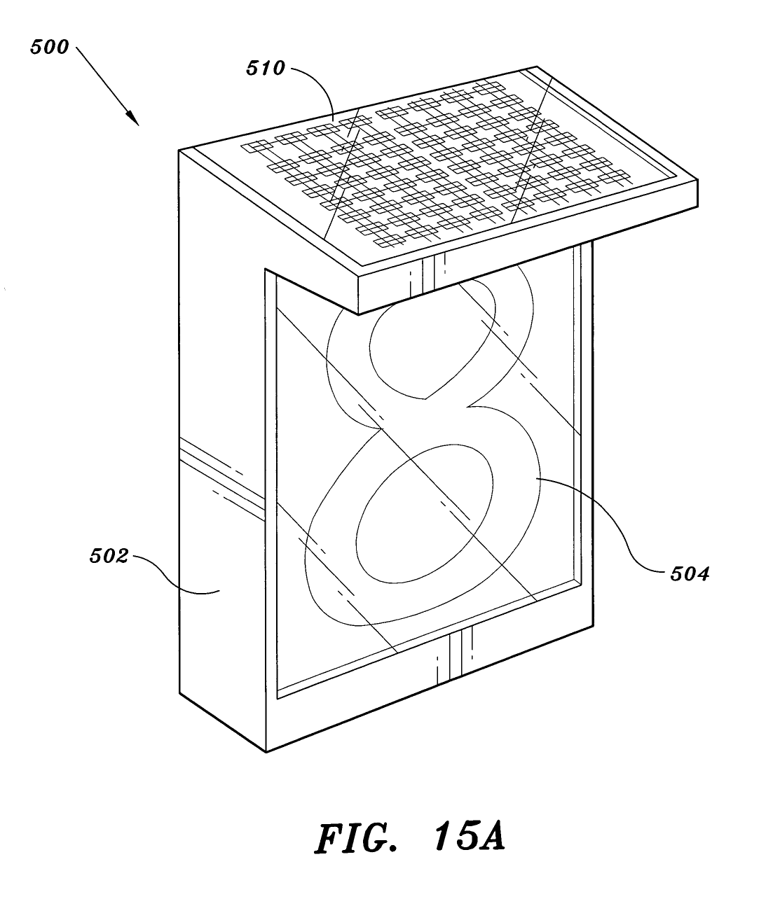

Address illumination element 400 in FIG. 14 has a housing 410, a solar panel 412, an alphanumeric character 414, and a cover 418. The housing 410 is generally rectangular, includes a front, rear, top, bottom, left, and right sides. The housing 410 includes a panel at the rear of the housing 410 that is removable via fastener(s) and is configured to be mounted and/or attached to a surface, such as a side of a house, a mailbox, etc. The housing 410 is preferably made of a rugged impact resistant resin, such ABS, PVC, polypropylene, polycarbonate, etc. Stored within the housing 410 are one or more rechargeable batteries and lighting circuitry. Each battery is preferably a AA size 900 mAh NiCad battery, though other rechargeable battery configurations may also be used.

The solar panel 412 is a flat rectangular plate-like member that converts sunshine during daylight hours to electrical energy and can power one or more LED(s) in the housing 410 and/or can recharge the rechargeable battery(s) in the housing 410. The solar panel 412 includes one or more solar cells, such as photovoltaic cells or the like, and is operably connected via a transistor switch to the rechargeable battery(s) and to the LED(s) via the lighting circuitry.

During daylight hours sunlight or light from other light sources is absorbed by the solar panel 412, and causes the solar panel 412 to generate electrical energy and charge the rechargeable battery(s). The transistor switch prevents any electrical energy generated by the solar panel 412 from powering the LED(s) until the ambient light level falls below a predetermined threshold, and then the transistor switch causes electrical energy stored in the rechargeable battery(s) to power the LED(s). The lighting circuitry may contain additional circuitry to adjust the ambient light level predetermined threshold, to prevent the rechargeable battery(s) from charging above a predetermined maximum level, to allow the LED(s) to be powered during daylight hours, etc.

The cover 418 is a flat plate-like member and is formed of transparent or translucent material of any suitable type, including acrylic, glass, polycarbonate, epoxy, resins, etc. The cover 418 is positioned on the front of the housing above the alphanumeric character 414. The solar panel 412 is positioned behind the alphanumeric character 414 within the housing 410. However, the solar panel 412 may alternatively be positioned on the top, bottom, left, or right side of the housing as desired.

The alphanumeric character 414 shown in FIG. 14 is configured as an optic light guide in the form of a “2” (two), but may be configured in the form of any desired alphanumeric character. The optic light guide or alphanumeric character 414 is preferably a flexible transparent cable that includes one or more LED inlets 416, and one or more refractors along the length of the light guide. Light emitted from each LED is passed through each LED inlet 416. Each refractor refracts the light from an LED as it passes through the refractor to concentrate the light into a concentrated round beam pattern. While any number of refractors may be utilized, the uniformity of light emitted through the light guide increases with the number of refractors employed. The alphanumeric character 414 is attached to and/or is positioned on the surface of the solar panel 412 proximate the front of the housing 410.

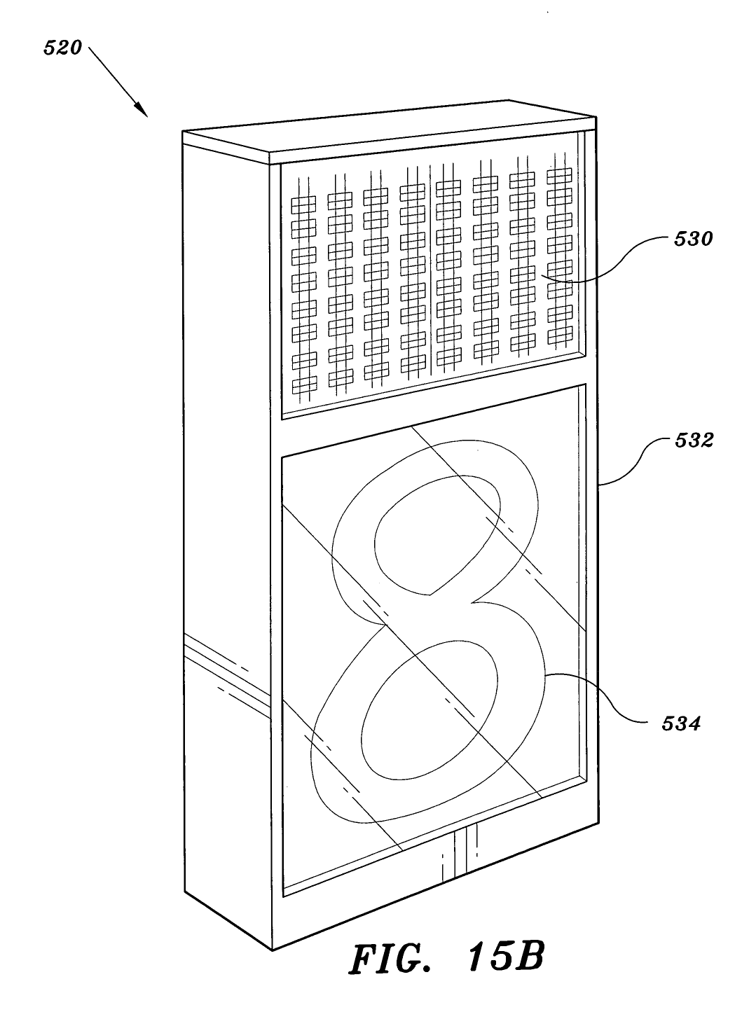

Address illumination element 500 in FIG. 15A has a housing 502, an alphanumeric character 504, and a solar panel 510. The housing 502 includes a front, rear, top, bottom, left, and right sides. The housing 502 includes a panel at the rear of the housing 502 that is removable via fastener(s) and is configured to be mounted and/or attached to a surface, such as a side of a house, a mailbox, etc. The housing 502 is preferably made of a rugged impact resistant resin, such ABS, PVC, polypropylene, polycarbonate, etc. Stored within the housing 502 are one or more rechargeable batteries and lighting circuitry. Each battery is preferably a AA size 900 mAh NiCad battery, though other rechargeable battery configurations may also be used.

The alphanumeric character 504 is carved or etched in the surface of a flat rectangular plate-like member of any suitable type, such as acrylic, polycarbonate, glass, epoxy, resins, etc. The character is configured in the form of an “8” (eight), but may be configured in the form of any desired alphanumeric character. The character 504 has no or low color and is clear or translucent to allow light emitted from one or more LEDs to pass through the character 504 (e.g., illuminate the character 504). The remaining portion of the flat-plate member in which the character is carved or etched is opaque or has high color and may be provided in the form of any color as desired.

The LED(s) are operably connected via the lighting circuitry to the solar panel 510 and are positioned behind the flat rectangular plate-like member in which the alphanumeric character 504 is carved or etched. Light emitted from each LED may be passed through a refractor to concentrate the light into a concentrated round beam pattern and to illuminate the inner housing 502 and, therefore, illuminate the character 504 for external viewing, particularly during nighttime hours. The cover is a flat rectangular plate-like member and is formed of transparent or translucent material of any suitable type, including acrylic, glass, polycarbonate, epoxy, resins, etc.

The solar panel 510 is positioned on the top of the housing 502 and extends perpendicularly in the front of the housing 502. The solar panel 510 is a rectangular plate-like member that converts sunshine during daylight hours to electrical energy and can power the LED(s) in the housing 502 and/or can recharge the rechargeable battery(s) in the housing 502.

The solar panel 510 is a rectangular plate-like member that converts sunshine during daylight hours to electrical energy and can power one or more LED(s) in the housing 502 and/or can recharge the rechargeable battery(s) in the housing 502. The solar panel 510 includes one or more solar cells, such as photovoltaic cells or the like, and is operably connected via a transistor switch to the rechargeable battery(s) and to the LED(s) via the lighting circuitry.

During daylight hours sunlight or light from other light sources is absorbed by the solar panel 510, and causes the solar panel 510 to generate electrical energy and charge the rechargeable battery(s). The transistor switch prevents any electrical energy generated by the solar panel 510 from powering the LED(s) until the ambient light level falls below a predetermined threshold, and then the transistor switch causes electrical energy stored in the rechargeable battery(s) to power the LED(s). The lighting circuitry may contain additional circuitry to adjust the ambient light level predetermined threshold, to prevent the rechargeable battery(s) from charging above a predetermined maximum level, to allow the LED(s) to be powered during daylight hours, etc.

Address illumination element 520 in FIG. 15B has a solar panel 530, a housing 532, and an alphanumeric character 534, as well as additional items described above. The housing 532 includes a front, rear, top, bottom, left, and right sides. The housing 532 includes a panel at the rear of the housing 532 that is removable via fastener(s) and is configured to be mounted and/or attached to a surface, such as a side of a house, a mailbox, etc. The housing 532 is preferably made of a rugged impact resistant resin, such ABS, PVC, polypropylene, polycarbonate, etc. One or more rechargeable batteries and lighting circuitry are contained within the housing 532. Each battery is preferably a AA size 900 mAh NiCad battery, though other rechargeable battery configurations may also be used.

The alphanumeric character 534 is carved or etched in the surface of a flat rectangular plate-like member of any suitable type, such as acrylic, polycarbonate, glass, epoxy, resins, etc. The character is configured in the form of an “8” (eight), but may be configured in the form of any desired alphanumeric character. The character 534 has no or low color and is clear or translucent to allow light to emitted from one or more LEDs to pass through the character 534 (e.g., illuminate the character 534). The remaining portion of the flat-plate member in which the character is carved or etched is opaque or has high color and may be provided in the form of any color as desired.

The LED(s) are electrically connected via the lighting circuitry to the solar panel 530 and are positioned behind the flat rectangular plate-like member in which the alphanumeric character 534 is carved or etched. Light emitted from each LED may be passed through a refractor to concentrate the light into a concentrated round beam pattern and to illuminate the inner housing 532 and, therefore, illuminate the character 534 for external viewing, particularly during nighttime hours. The cover is also a flat rectangular plate-like member and is formed of transparent or translucent material of any suitable type, including acrylic, glass, polycarbonate, epoxy, resins, etc.

The solar panel 530 is positioned on the top of the housing 532 and extends perpendicularly in the front of the housing 532. The solar panel 530 is a rectangular plate-like member that converts sunshine during daylight hours to electrical energy and can power one or more LED(s) in the housing 532 and/or can recharge the rechargeable battery(s) in the housing 532. The solar panel 530 includes one or more solar cells, such as photovoltaic cells or the like, and is operably connected via a transistor switch to the rechargeable battery(s) and to the LED(s) via the lighting circuitry.

During daylight hours sunlight or light from other light sources is absorbed by the solar panel 530, and causes the solar panel 530 to generate electrical energy and charge the rechargeable battery(s). The transistor switch prevents any electrical energy generated by the solar panel 530 from powering the LED(s) unit the ambient light level falls below a predetermined threshold, and then the transistor switch causes electrical energy stored in the rechargeable battery(s) to power the LED(s). The lighting circuitry may contain additional circuitry to adjust the ambient light level predetermined threshold, to prevent the rechargeable battery(s) from charging above a predetermined maximum level, to allow the LED(s) to be powered during daylight hours, etc.

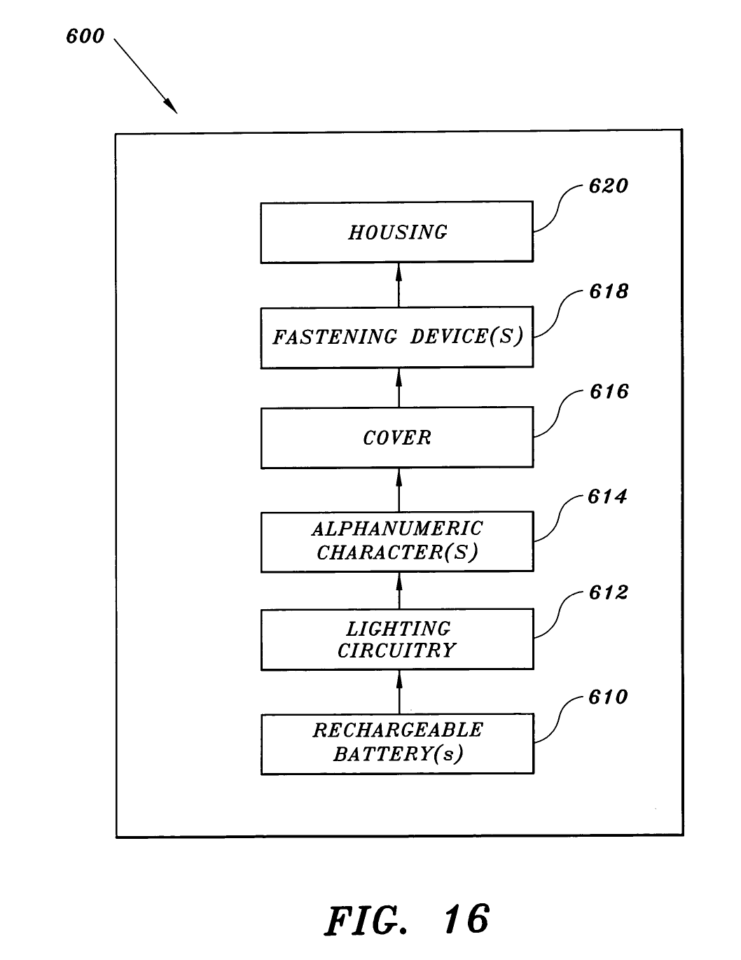

The diagram 600 shown in FIG. 16 represents components of any of the previously described address illumination elements 300, 400, 500, and 520. The components include rechargeable batteries 610, lighting circuitry 612, alphanumeric character(s) 614, a cover 616, fastening device(s) 618, and a housing 620.

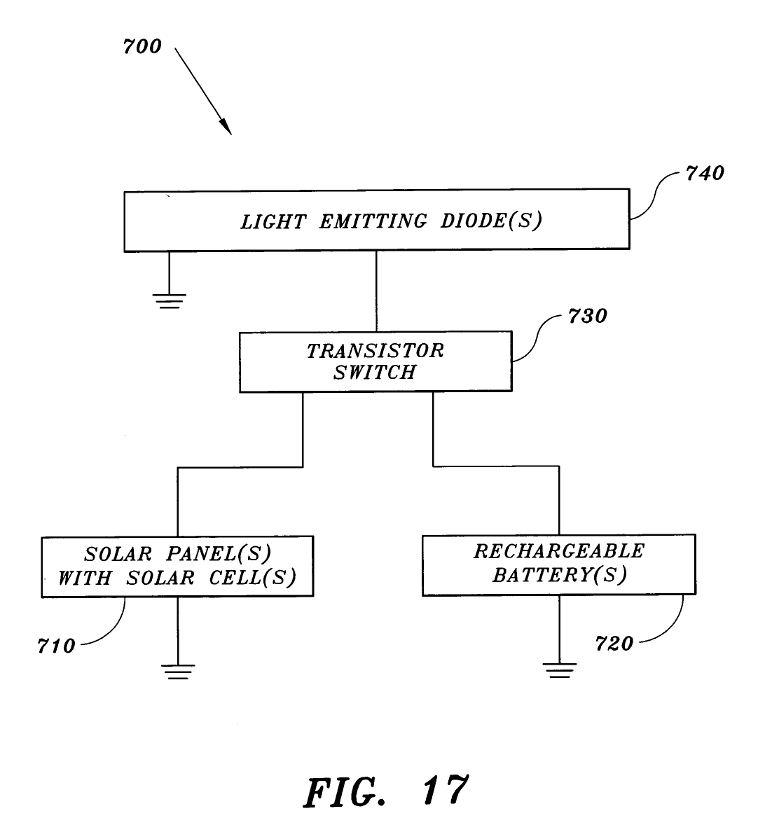

FIG. 17 illustrates circuitry 700 for any of the previously described address illumination elements 300, 400, 500, and 520. The circuitry 700 includes one or more solar panel(s) with one more solar cell(s) 710, one or more rechargeable battery(s) 720, a transistor switch 730, and one or more LED(s) 740.

The transistor switch 730 prevents any electrical energy generated by the solar panel(s) 710 to power the LED(s) 740 when the ambient light level is at or above a predetermined threshold. When the ambient light level falls below the predetermined threshold the transistor switch 730 causes electrical energy stored in the rechargeable battery(s) 720 to power the LED(s) 740. The circuitry 700 may contain additional circuitry to adjust the ambient light level predetermined threshold, to prevent the rechargeable battery(s) from charging above a predetermined maximum level, to allow the LED(s) 740 to be powered during daylight hours, etc.

The address illumination assembly is configured to counter and subsequently eliminate the problem of finding an address at night. The assembly allows the fire department, the police, and any other emergency service to find the address at critical times when every second counts.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. An address illumination assembly comprising:
at least one alphanumeric element having a housing with a front, a rear;
a solar panel in the housing;
an alphanumeric character in the housing,
at least one rechargeable battery in the housing and electrically interconnected with the solar panel and the alphanumeric character;
a cover interconnected with the housing;
lighting circuitry in the housing; and
at least one light emitting diode (LED) in the housing.

2. The address illumination assembly according to claim 1, wherein said housing includes a panel at the rear of the housing that is removable via at least one fastener and is configured to be mounted/attached to a surface.

3. The address illumination assembly according to claim 2, wherein said housing is of a rugged impact resistant resin.

4. The address illumination assembly according to claim 3, wherein said resin is acrylonitrile/butadiene/styrene (ABS), polyvinyl chloride (PVC), polypropylene, or polycarbonate.

5. The address illumination assembly according to claim 1, wherein said at least one rechargeable battery is a NiCad battery.

6. The address illumination assembly according to claim 1, wherein the alphanumeric character is configured as an optic light guide.

7. The address illumination assembly according to claim 6, wherein the optic light guide is a flexible transparent cable having a length that includes at least one LED inlet, and at least one refractor along the length of the optic light guide.

8. The address illumination assembly according to claim 6, wherein the alphanumeric character is attached/positioned on the solar panel proximate the cover.

9. The address illumination assembly according to claim 1, further comprising a transistor switch, wherein during daylight hours sunlight or light from other light sources is absorbed by the solar panel, causes the solar panel to generate electrical energy and charge the at least one rechargeable battery, and the transistor switch prevents any electrical energy generated by the solar panel to power the at least one LED, and when the ambient light level falls below a predetermined threshold the transistor switch causes electrical energy stored in the at least one rechargeable battery to power the at least one LED.

10. The address illumination assembly according to claim 9, wherein the lighting circuitry is configured to adjust the ambient light level predetermined threshold.

11. The address illumination assembly according to claim 9, wherein the lighting circuitry is configured to prevent the at least one rechargeable battery from charging above a predetermined maximum level.

12. The address illumination assembly according to claim 1, wherein the cover a flat plate-like member.

13. The address illumination assembly according to claim 12, wherein the cover is formed of transparent or translucent material.

14. The address illumination assembly according to claim 13, wherein the cover is formed of acrylic, glass, polycarbonate, epoxy, or resin.

15. The address illumination assembly according to claim 1, wherein, wherein the alphanumeric character is carved or etched in a surface of a flat rectangular plate-like member.

16. The address illumination assembly according to claim 15, wherein, wherein the plate-like member is acrylic, polycarbonate, glass, epoxy, or a resin.

17. The address illumination assembly according to claim 15, wherein the solar panel is positioned on the top of the housing and extends perpendicularly in the front of the housing.

18. The address illumination assembly according to claim 15, wherein the solar panel is positioned on the top of the housing and extends vertically above the top of the housing.

19. The address illumination assembly according to claim 15, further comprising a transistor switch, wherein during daylight hours light is absorbed by the solar panel, causes the solar panel to generate electrical energy and charge the at least one rechargeable battery, and the transistor switch prevents any electrical energy generated by the solar panel to power the at least one LED, and when the ambient light level falls below a predetermined threshold the transistor switch causes electrical energy stored in the at least one rechargeable battery to power the at least one LED.

20. The address illumination assembly according to claim 15, wherein the lighting circuitry is configured to adjust the ambient light level predetermined threshold and to prevent the at least one rechargeable battery from charging above a predetermined maximum level.
